(19) United States
(12) Patent Application Publication
(10) Pub. No.: US 2009/0262746 A1
(43) Pub. Date: Oct. 22, 2009

(54) ROUTER AND ROUTING METHOD FOR PORTABLE INTERNET SERVICE

(75) Inventor: Min-Kon Kwak, Seoul (KR)

Correspondence Address: AMPACC LAW GROUP, 3500 188th St. SW, Lynnwood, WA, 98037, US

(73) Assignee: POSDATA CO., LTD., GYEONGGI-DO (KR)

(21) Appl. No.: 12/441,376

(22) PCT Filed: Sep. 20, 2007
(86) PCT No.: PCT/KR07/04612

§ 371 Date: Mar. 13, 2009

(30) Foreign Application Priority Data
Sep. 21, 2006 (KR) 10-2006-0091638

(51) Int. Cl. H04L 12/56

(52) U.S. Cl. 370/401

(57) ABSTRACT

The present invention relates to a router (for example, ACR) which provides a mobility function and a delivery function with a portable Internet core network while controlling RAS, which is a base station, as a basis network element of an access network in a portable Internet (for example, WiBro) service, and particularly, provides a new paging algorithm in order to overcome the limit of a paging in a conventional routing scheme, and to effectively process the buffering function for seamless connection maintenance and the paging function for a destination terminal with respect to the terminated call of a terminal in a non-active mode. A router of the present invention includes a control plane that buffers a data packet for a non-active mode, and performs a paging for a corresponding non-active mode terminal.

### TECHNICAL FIELD

The present invention relates to a router (for example, ACR) which provides a mobility function and a delivery function with a portable Internet core network while controlling base stations (or RAS: Radio Access station), as a basis network element of an access network in a portable Internet (for example, WiBro) service, and particularly, provides a new paging algorithm in order to overcome the limit of a paging in a conventional routing scheme, and to effectively process the buffering function for seamless connection maintenance and the paging function for a destination terminal with respect to the terminated call of a terminal in a non-active mode.

### BACKGROUND ART

FIG. 1 shows the configuration of a portable Internet service network. ACR (Access Control Router) shown in FIG. 1 should easily control the connection by the call access in anytime, anywhere, in spite of the movement of PSS (Portable Subscriber Station) which is a terminal. Particularly, in view of a service, the Terminated Call Processing function is very important. For this, the paging function in the non-active mode has to be implemented.

ACR (Access Control Router) is a kind of router that monitors RAS which is a base station and supports the portability of the terminal. Therefore, the data for the destination terminal of a base station having jurisdiction is transmitted through the routing function of ACR. As a rule, the routing is performed through a Next-hop information instead of the information of a whole path. And, the next-hop information is performed through a routing table search according to a hierarchical composition having the order of Direct delivery entry, Host-specific entry, Network-specific entry and default entry.

However, on the contrary to the conventional wired network, the routing method on a wireless portable internet system should support the IP portability of a terminal. Hence, the host routing by the host assignment item is generally used. That is, the IP address of the terminal which normally operates is recorded in the routing table within ACR and a message is transmitted to a specific destination terminal which coincides after comparing with the destination address of the message which arrived at ACR.

FIG. 2 is a routing table referred for the routing function, FIG. 3 shows a flowchart illustrating the process of data packet processing by using the routing table.

As shown, as a rule, the column item of the routing table is comprised of the fields of Mask, Destination address, Next-hop, flag, Reference Count (R.C), Use and Interface. The Mask indicates the mask applied to the destination IP address, and the Destination address indicates the destination host address or the destination network address. The Next-hop indicates the address of the next router to which a packet should be delivered. The flag determines the operation state of the related router and determines whether the value of the destination address field is an host or a router, and determines whether the destination exist in another network. The Reference count indicates the number of users who are presently using this path, and the Use indicates the number of packet which is delivered to a corresponding destination from a corresponding router, and the Interface indicates the identification name of a corresponding row.

As shown in FIG. 3, the conventional router determines through a routing table whether the destination of arrival packet exists within a corresponding network, and directly transmits the packet having the destination within a corresponding network to a destination terminal. Since the process cannot be changed for a normal operation, the processing is performed in the sequence of the arrival of a packet.

That is, when a data packet has arrived, the item of each row of the routing table is sequentially brought to be applied. Firstly, AND operation is performed to the value of the destination address which is in the IP packet head of the received packet with the mask field value. In case this coincides with the destination field value of the same row, the gate flag is checked whether the gate flag of the same row is designated.

In case the gate flag is designated, it means that the destination address exists in another network, therefore, a corresponding message is transmitted to the next-hop address of the same row. In case the gate flag is not designated, it means that the destination address exists in the current network, therefore, it is directly delivered with the address from the MAC (Medium Access Control) value. In case the value applied with the mask field does not coincide with the destination address, then, the item of the next line is continuously brought from the routing table and the same task is repeated.

And, in case the value does not coincide with the destination address to the end, the corresponding message is discarded and the error-processing is performed while answering with the ICMP message.

However, as shown in FIG. 2, as usual, the last row of a routing table is formed of a default row designating a mask and a destination address as ‘0.0.0.0’, therefore, the occurring of an error can be prevented. Based on such general routing principles, the procedure that is generated when a packet which sets a terminal in idle mode as a destination arrived in ACR in a conventional wireless portable internet network will be illustrated.

As a rule, the operation state of a terminal is defined as Active, Sleep, and Idle mode. Sleep and Idle mode are used in order to save the electricity power and effectively utilize the resources.

Firstly, when the terminal of a wireless portable internet system is Power ON, the operation mode of the terminal becomes the active mode. At this time, in case the time when a buffer is vacant exceeds the time which is set in advance in order to transit to the sleep mode, it transits from the active mode to the sleep mode. Further, in case there is no data which is transmitted between the mobile terminal and the base station for a predetermined time in the active mode, or in order to prevent the battery consumption, it is transmitted to the idle mode.

The sleep mode and the idle mode have a difference in the holding information for data path restoration between the terminal and the RAS. However, there is no difference in describing the paging procedure according to the concept of the present invention. Therefore, for the sake of convenience in illustration, it will be described based on the idle mode. However, the present invention can be applied to the non-active mode which is a concept including the sleep mode and the idle mode. Next, it will be exemplified that the paging function is performed by using the general routing function in the idle mode of a terminal.

In case the terminal is transmitted to the idle mode, the session connection route between the ACR and the terminal is deleted, and the record on the corresponding terminal in the ACR routing table is expunged. At this time, in case of the arrival data packet in which the receiving terminal of the idle mode is a destination, the information by the terminal host was not registered by the routing table. Therefore, in case the conventional routing and routing method are used, the related data packet is discarded or transmitted to a default router and roams about from place to place, so that it became the factor which finally increases the traffic processing load of a network.

FIG. 4 shows a configuration diagram illustrating the processing method of a data packet for an idle mode terminal of the conventional router. In FIG. 4, the conventional ACR can be classified with a data plane for the routing function and the control plane for processing all kinds of control messages.

In case it is assumed that the host routing mode is used for the support of the mobility of the terminal, when the incoming data packet arrived in the ACR, in case the destination terminal is the active mode, it is transmitted to a corresponding RAS like the arrow \textcircled{1}. In case the destination terminal is the idle mode, since the information of the related terminal is expunged in the routing table, it is discarded or it can be routed to a default router like the arrow \textcircled{2}. When the default router is designated as another ACR, the arrival message is transmitted to another ACR like the arrow \textcircled{2}, and, in result, it will be degraded to a spam message which worsens the load in a network.

As described above, when the function necessary for the paging process for the idle mode terminal is directly treated in the data plane, it can cause a traffic overflow due to the buffering and the compatibility problem of the routing algorithm of the conventional commercial product. Hence, it is not desirable.

In the meantime, in order that the paging for the idle mode terminal is performed while using a general router in a portable Internet system, an additional anchor PC and a relay PC have to be equipped. The anchor PC is an apparatus that is used to receive the paging request at ACR primarily and process it, including RAS which is located in the place where the distance from ACR is shorter. The relay PC is designed to perform the procedure of paging processing with each PA corresponding to each idle mode terminal, and it is implemented on the inside of each RAS in which PA is generated, or inside of RAS presiding over the paging group.

As described, even when a PC (paging controller) apparatus for additional paging is equipped, as the data packet of idle mode is transmitted to the additional PC (paging controller) apparatus, the load situation of the network is worsened, and it is not effective method in view of the data seamless connection

Therefore, in case of the non-active mode like the idle mode, in order to support the paging processing function for a terminal, the router and routing method in which the change of general function structure is minimized for compatibility with an exiting network and the data seamless connection is guaranteed although a paging is generated, and the serious performance delay due to the paging is not generated are required.

### DISCLOSURE OF INVENTION

### Technical Problem

Accordingly, the present invention has been made in view of the above problems occurring in the related art, and it is an object of the present invention to provide a router and routing method which is capable of preventing a data packet that sets a non-active mode terminal as a destination from being lost or being roamed from place to place in a network.

Further, another object of the present invention is to provide a router and routing method capable of guaranteeing the seamless connection for data packets that sets a non-active mode terminal as a destination.

Further, still another object of the present invention is to provide a router capable of minimizing a change from the design of an exiting router while achieving the above objects.

In the meantime, one of the improvements that the present invention suggests is to provide a change of the routing table which additionally processes the message which is not searched through the routing table and a quick paging procedure.

Further, another improvement of the present invention is to provide a buffering function in order to guarantee the seamless connection by eliminating the time delay due to the establishment of a new linkage path, and to prevent the loss of the related data message.

Further, still another improvement of the present invention is to provide an additional processor in a control plane in order to effectively process the message designated to the terminal of the idle mode so as not to give a load to an existing rout ing processor. After the additional processor extracts the paging information of the message and, temporarily, stores it into the memory, the paging procedure is rapidly performed. When the paging procedure is successfully performed, the data message which is temporarily stored is transmitted and the IP of the terminal paged in the ACR routing table is registered, so that a message can be normally delivered.

### Technical Solution

In order to accomplish the object, according to an aspect of the present invention, provided is a router comprising a data plane that transfers a data packet between a core network and a base station equipment; a first control plane that controls a session between the core network and the base station equipment for sending the data packet; and a second control plane that buffers the data packet in which a non-active mode terminal is a destination which is routed from the data plane, and performs a paging for a corresponding non-active mode terminal.

According to another aspect of the present invention, provided is a routing method comprising the steps of (a) searching a destination address of an arrived data packet in a routing table; (b) buffering the data packet in a paging buffer when the destination address is searched in a default row of the routing table; (c) searching a destination terminal identification value of the buffered data packet in a non-active terminal list; (d) forming a data path with a corresponding non-active terminal according to an information recorded in the searched list; and e transmitting the buffered data packet to the terminal through the data path.

### ADVANTAGEOUS EFFECTS

Accordingly, the router and routing method according to the present invention have the effect that the data packet of which the destination is a non-active mode terminal is a destination is prevented from being lost or being roamed from place to place in a network.

Further, the router and routing method according to the present invention have the effect that prevents the loss of data packets having the non-active mode terminal as a destination and guarantees the seamless connection during establishing the connection with a destination terminal through the buffering function.

Further, the router and routing method according to the present invention have the effect that can prevent the loss of the data packet in which the non-active mode terminal is a destination and can achieve the guarantee of the seamless connection while minimizing the change of the conventional router design. Further, as to the implementation according to the present invention, the decentralized control is performed by separately processing the routing and the paging, so that the independence of the ACR function processing module can be guaranteed and the message can be compatible with the conventional router and the utility of using the power of a terminal, the wireless resource of base station, and the IP resource is accomplished.

In conclusion, in case the paging implementation method for the non-active mode terminal in a wireless portable internet network is implemented like the present invention, the data seamless connection can be guaranteed and the compatability with the conventional router can be obtained and the processing loading due to a paging is prevented as much as possible, thereby, an optimization can be accomplished in the whole network.

### BRIEF DESCRIPTION OF THE DRAWINGS

FIG. 1 is a conceptual diagram showing the network architecture of a portable Internet system of the related art.

FIG. 2 is a routing table of the related art.

FIG. 3 shows a flowchart illustrating the process of data packet processing by using a routing table of the related art.

FIG. 4 shows a configuration diagram illustrating the data packet processing method for an idle mode terminal of the conventional router.

FIG. 5 shows a configuration diagram illustrating a router having the data packet processing mode for an idle mode terminal according to an embodiment of the present invention.

FIG. 6 is a configuration diagram of a second control plane of FIG. 5.

FIG. 7 is a routing table according to an embodiment of the present invention.

FIG. 8 is the list of a non-active terminal according to an embodiment of the present invention.

FIG. 9 is a flowchart of the routing method according to an embodiment of the present invention.

FIG. 10 is a message transmission flowchart in a portable internet network according to an embodiment of the present invention.

### MODE FOR THE INVENTION

Hereinafter, exemplary embodiments of the present invention will be described with reference to the accompanying drawings. The same elements will be designated by the same reference numerals all through the following description and drawings although they are shown in different drawings. Further, in the following description of the present invention, a detailed description of known functions and configurations incorporated herein will be omitted when it may make the subject matter of the present invention rather unclear.

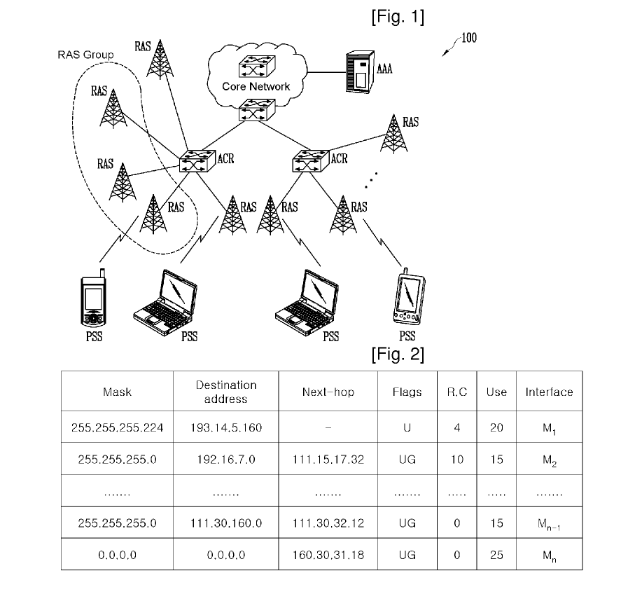

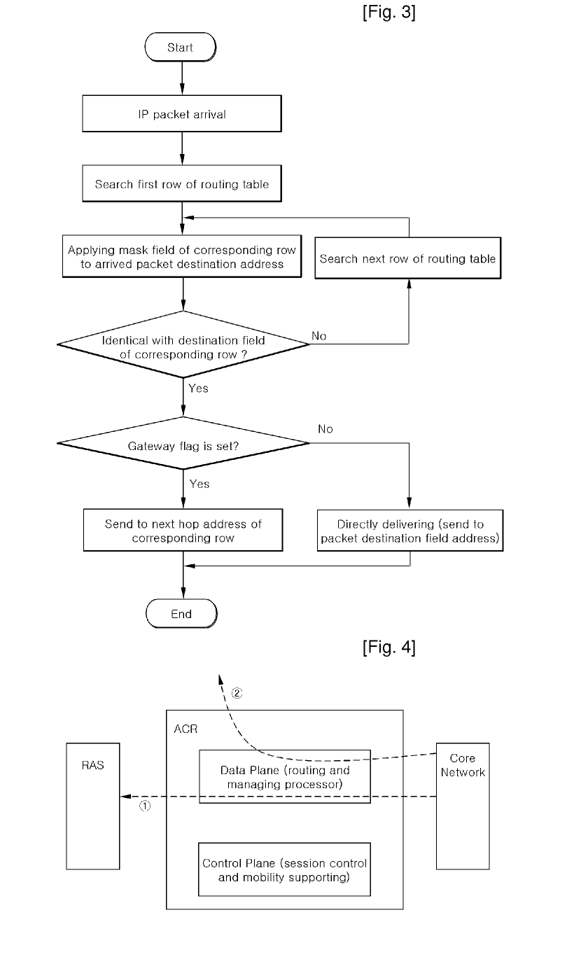

As a rule, as shown in FIG. 1, the structure of a wireless portable internet network is classified as the access network consisting of ACR, RAS and a terminal and the core network. The core network can be subdivided into the CSN (Connectivity Service Network) taking charge of processing the connection function for the call establishment and the service network managing a service. According to such network architecture, the ACR of the access network should include the paging function in order to process an incoming call, and, for this, the PC (Paging Controller) and LR (Location Register) function should be mounted.

PC has the function of controlling the terminal of the idle mode inside the network, and includes an information such as the current PGID (Paging Group ID) which is the location information of the terminal, the paging cycle, and the paging offset, and the service flow information. Here, due to the traffic increment, it is undesirable to implement the PC apparatus with an additional apparatus. It is desirable to perform the anchor PC function and the routing function in one ACR equipment. Therefore, in the present embodiment, an ACR having the routing function and anchor PC function is suggested.

The suggested ACR of this embodiment plays the role of controlling for the call connection between the base station and the terminal and of supporting the mobility while performing the routing function. Therefore, the function of controlling the base station is added to the existing router function, furthermore, a change in the basic configuration of a routing table is demanded for the maintenance of the portability of a terminal.

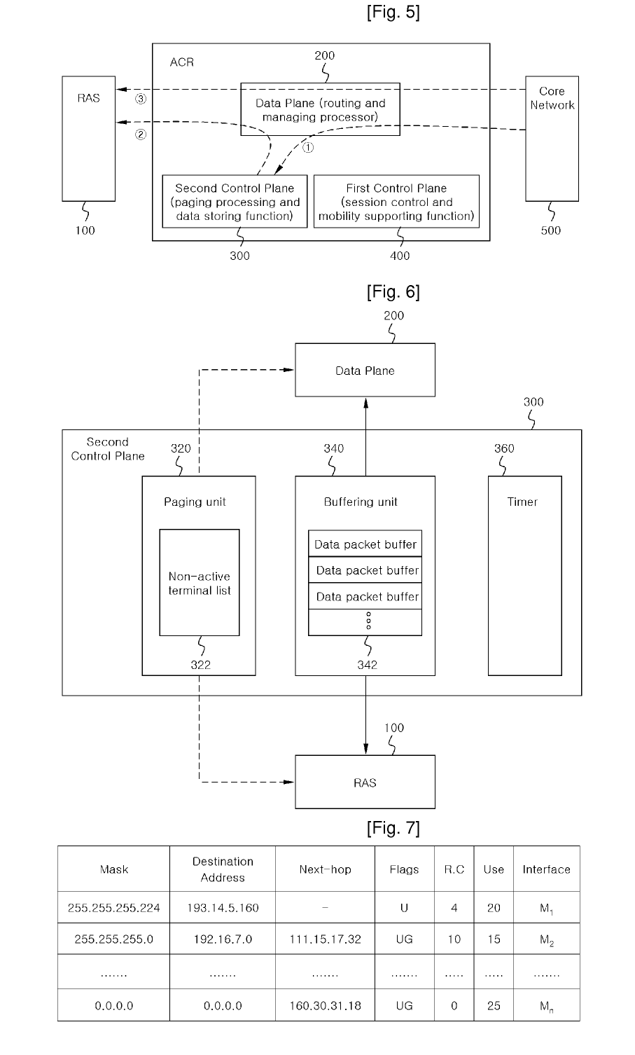

FIG. 5 shows a configuration diagram illustrating a router having the data packet processing mode for an idle mode terminal according to an embodiment of the present invention, FIG. 6 is a configuration diagram of a second control plane among the configuration of FIG. 5.

The ACR of this embodiment has a basic structure shown in FIG. 5. In order to effectively perform the paging of the idle mode, briefly, the internal structure of ACR provides a data plane 200 that processes a routing, a FA (Foreign Agent) and the managing function, a the first control plane 400 that processes the session control and the authentication/accounting, and a second control plane 300 which is in charge of the paging control, the location register and the temporary data storing function.

The data plane 200 and two control planes 300, 400 comprise a processing means that can process a corresponding function and a storage means for storing data required for the performance of the corresponding function. The processing means can be implemented with a software module. However, in this case, one processor hardware should perform the function of three planes, thus, the actual profit obtained by classifying into three planes is not large.

Therefore, it is desirable that the three processing means are implemented with individual processor hardwares which are independent each other, and particularly, in the present invention, the data plane 200 and the second control plane 300 are comprised of processor hardwares which are independent each other.

When the data packet for an idle mode terminal arrived in the data plane 200 of ACR, the data plane 200 transmits it to the second control plane 300 which is designated as a next-hop of the last row default row of a routing table like the arrow \textcircled{1}. When the second control plane 300 receives a report that the data path from the terminal to the AC is re-established, it transmits the buffered data packet to RAS to which a corresponding terminal belongs like the arrow \textcircled{2}. At this time, the information of the related terminal is designated to the routing table in the form of the host assignment item. And then, the arrived data packet which is not buffered can be transmitted like the arrow \textcircled{3} to a destination terminal which is converted into the active mode after a normal routing.

In conclusion, \textcircled{1} among the arrow numbers of FIG. 5 indicates the buffering path of data packet which is received during the time required for processing the paging, when the data packet in which the terminal of the idle mode is a destination is inputted. \textcircled{2} indicates the transmission path of data which is processed for paging with the control plane and the corresponding terminal of the idle mode, and buffered. \textcircled{3} indicates the transmission path of data packet for the identical terminal to which data packet is continuously transmitted after the transmission of data which is processed for paging and buffered.

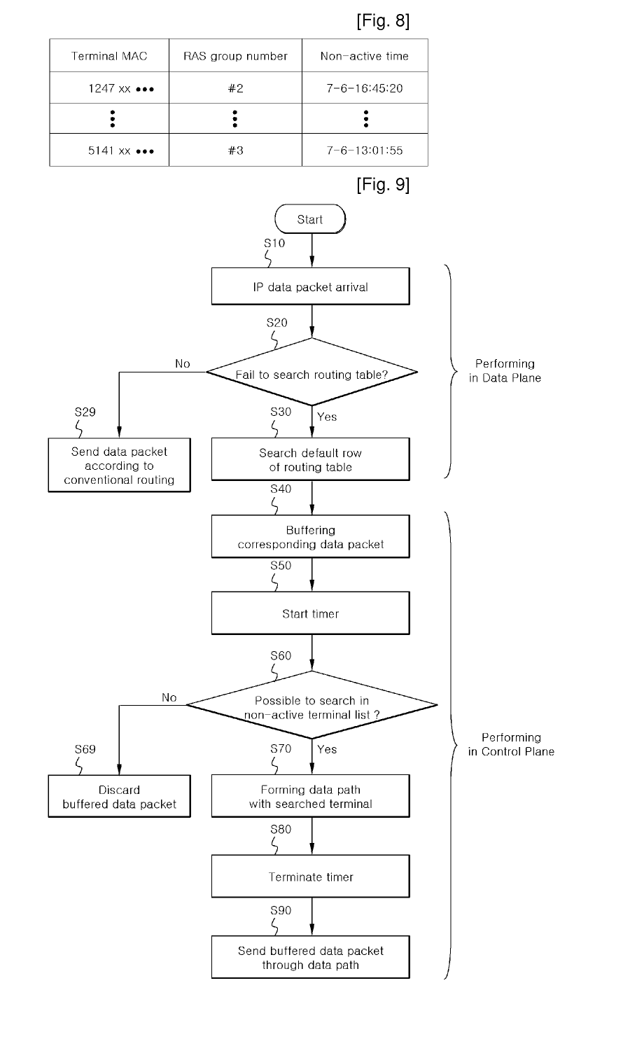

In order to perform the above process, as shown in FIG. 6, the second control plane 300 comprises a paging unit 320 that performs a paging for an idle mode terminal, a buffer 340 for storing data packet in which the idle mode terminal is a destination, and which is inputted during the paging, and a timer 360 for measuring the paging time for the idle mode terminal. Here, the paging unit 320 includes a non-active terminal list as shown in below FIG. 8, and the buffer 340 includes a non-active packet buffer 342 for buffering the data packet for the idle mode terminal.

FIG. 7 is a routing table according to an embodiment of the present invention, which is equipped in the data plane of FIG. 5. FIG. 8 is the list of a non-active mode terminal according to an embodiment of the present invention, illustrating the list of a non-active mode terminal equipped in the second control plane of FIG. 5.

The data plane 200 can have a routing table as shown in FIG. 7. The feature of the table shown in FIG. 7 is in the recorded value of the last row designating the default router. The destination address and mask of the last row designates the processing path of data packet in which ‘0.0.0.0’ is recorded and which is unable to seek for a route.

The address for the second control plane is recorded in the next-hop information of the last row of the routing table. According to the record, the data packet in which the destination does not exist in the table can be altogether delivered to the second control plane 300.

The second control plane 300 can possess the non-active mode terminal list as shown in FIG. 8. The non-active mode terminal list provides the information of the terminal in which the corresponding ACR and the data path were formed and converted into the idle mode. That is, the identification value (for example, MAC address) of the terminal converted into the idle mode and the RAS or the paging group information in which a corresponding terminal was connected can be included. As shown in FIG. 1, the paging group is consisted of a plurality of designated RASs, being classified in ACR for the convenience of the RAS administration. Here, if necessary, the non-active terminal list can be consisted of part of elements, or a new element can be added.

Firstly, it will be illustrated that the processing procedure at ACR of the embodiment and the information which is accordingly recorded when the terminal is converted into the idle mode. When it is converted into the idle mode, the terminal notifies to RAS that the terminal itself is converted into the idle mode, and the notification is transmitted to ACR. The ACR stores a hardware identification value (for example, MAC identification value) of the terminal corresponding to the idle mode change notification, and the base station connection information in which the data path for the corresponding terminal existed in the non-active mode terminal list of the second control plane. The terminal hardware identification value can become a MAC (Media Access Code) value which is given to each terminal. The base station connection information can become a corresponding RAS group identification value when grouping RASs which were connected to the ACR.

In another case, the time in which it goes into to the idle mode can be recorded, and at this case, the data structure of the non-active terminal list is illustrated in FIG. 8.

As shown in FIG. 7, the mask field ‘0.0.0.0’ and the destination address ‘0.0.0.0’ default router value is inputted into the last row of the routing table, and the next-hop is designated to be a second control plane 300 having the buffering and paging function. And the second control plane 300 comprises a memory that can temporarily store the packet which has already arrived before paging, designed to include the buffering function. Based on such implementation design, the procedure of a new paging function of the idle mode will be described.

FIG. 9 is a flowchart showing the routing method according to an embodiment of the present invention, and is a flowchart showing the routing method in case of applying the ACR structure illustrated in FIG. 6.

In case the data packet in which the terminal of the idle mode is a destination arrived, the processing step at the ACR of the embodiment is comprised of the step S20 of searching the destination address of the arrived data packet in a routing table; in case the destination address is searched in the default row of the routing table S30, the step S40 of buffering the data packet in a paging buffer; the step S60 of searching the destination terminal identification value (for example, MAC identification value) of the buffered data packet in the non-active mode terminal list; the step S70 of forming a data path with a corresponding idle mode terminal according to the information recorded in the searched list; and the step S90 of transmitting the buffered data packet to the terminal through the data path.

Here, after the step S40, it may further comprise the step S50 of starting the timer for measuring the data path forming time. And it may further comprise the step S80 of terminating the timer, after the step S70. Further, it may further comprise the step of transmitting the data packet having the identical destination address which arrived to the terminal through the data path without the buffering of the second control plane 300, after the step S90. At step S20, the data packet for the active mode terminal is processed by the conventional routing method according to the search result in the routing table S29.

On the other hand, when the data packet for the idle mode terminal arrived at the data plane 200 of the ACR, the destination terminal is the idle mode, therefore, the destination address in the IP header of the corresponding packet is already deleted in the routing table that the data plane 200 has. In this case, according to the step S30, the data plane 200 transmits the corresponding packet to the second control plane 300 which is designated as a next-hop of the last row (the default row) of the routing table having the mask of ‘0.0.0.0’ and destination address.

The second control plane 300 buffers the corresponding packet in order to establish the incoming path for the receiving packet S40, starting the timer for measuring the time required for a paging S50, searching the paging group information of the related terminal corresponding to the destination address of the corresponding data packet, by searching the non-active mode terminal list with the MAC value of the corresponding terminal S60. In case it is not searched at step S60, the corresponding data packet is determined to be independent with the terminal that the ACR manages, so that the buffered data is discarded S69 and the timer is reset. In case the corresponding terminal is searched at step S60, a data path is formed with the terminal which is searched by performing a paging according to a predetermined procedure S70, and the timer is terminated S80.

Then, the second control plane 300 transmits the buffered data packet through the formed data path. The data plane transmits the data packet which is continuously transmitted to the same destination through the formed data path. At this time, the data plane 200 can perform the synchronization adjustment for the paging time measured by the timer with the transmission system of the corresponding data packet.

After the data path is formed, the arrival data packet which is not buffered can be transmitted to the destination terminal which is converted into the active mode through a normal routing. For this, either before or after the step of S70, the step of beginning the data buffer timer and the step of terminating the data buffer timer S80 as shown in FIG. 9 S50 are performed and the time required for paging can be measured. In another case, the steps relating with the timer can be omitted.

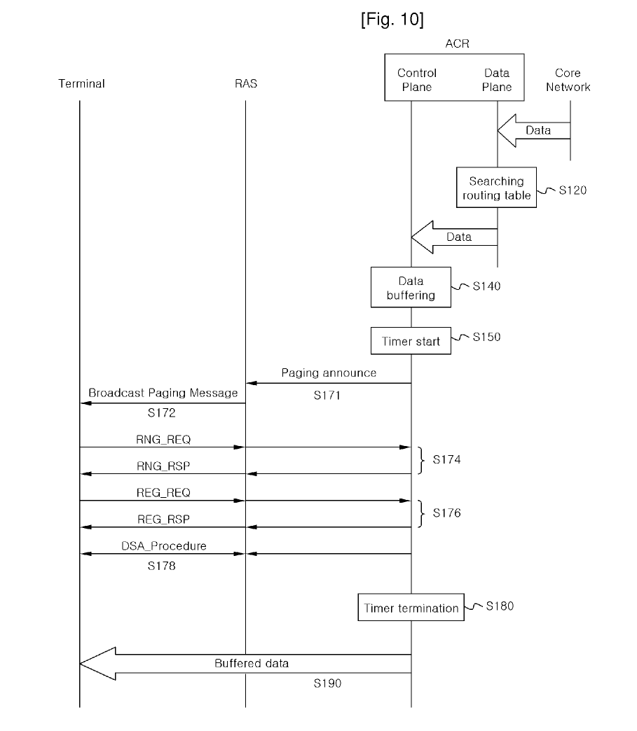

FIG. 10 is a message transmission flowchart in a portable internet network according to an embodiment of the present invention.

The step of S120 of FIG. 10 corresponds to the step of S20 and the step of S30 of FIG. 9, the step of S140 and the step of S150 correspond to the step of S40 and the step of S50 respectively, and the step of S171 to the step of S178 correspond to the step of S70. Among them, the step of S171 to the step of S178 shows the detail step in which the second control plane 300 performs the paging procedure and re-establishes the data path. The detailed description is as follows:

Firstly, the paging announce for the corresponding terminal is delivered to each RAS of the paging group of the corresponding terminal which is searched S171. The RAS which received the paging announce broadcasts the paging message for the corresponding terminal S172. The corresponding terminal receiving the paging message performs a ranging procedure with the base station S184.

The ranging is to correct the timing, the electric power, and the frequency information between the RAS and the subscriber terminal to be identical. As shown, the RAS takes the initiative in performing the ranging by receiving the necessary information from the ACR. After performing the ranging, the RAS transmits the result information about the ranging to the ACR. In case the ranging procedure is completed, the network registration procedure is performed S186.

As shown, the corresponding terminal transmits the registration request REG-REQ message to the base station. After receiving the message, the RAS registers the terminal in the network through the ACR, and transmits the registration response REGRSP message to the terminal. Thereafter, the DSA (Dynamic Service Addition) procedure setting up an additional information for the service application is performed S178, thereby, the data path is finally set up. Thereafter, the step of S180 and the step of S190 of FIG. 10 correspond to the step of S80 and the step of S90 of FIG. 9.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

1. A router comprising:
a data plane for transferring data packet between a core network and a base station, and performing a routing by using a routing table when the data packet of which a destination is a non-active mode terminal is received;
a first control plane for controlling a session between the core network and the base station to transfer the data packet; and
a second control plane for buffering the data packet in which a non-active mode terminal is a destination and which is routed from the data plane, and performing a paging for a corresponding non-active mode terminal.

2. The router of claim 1, wherein the data plane is implemented by a processor hardware, and the second control plane is implemented by another processor hardware.

3. The router of claim 1, wherein the second control plane includes identification values of non-active mode terminals and a base station connection information.

4. The router of claim 3, wherein the identification value is a MAC identification value.

5. The router of claim 3, wherein the base station connection information is a base station group identification value grouping a base stations which are connected to the router.

6. The router of claim 1, wherein the second control plane includes a non-active packet buffer for buffering data packet for the non-active mode terminal.

7. The router of claim 1, wherein the routing table includes a row that indicates the second control plane through a default path.

8. The router of claim 1, wherein the second control plane includes a timer that measures a time required for paging the non-active terminal.

9. A routing method comprising the steps of:
(a) searching a destination address of an arrived data packet in a routing table;
(b) buffering the data packet in a paging buffer when the destination address is searched in a default row of the routing table;
(c) searching a destination terminal identification value of the buffered data packet in a non-active terminal list;
(d) Establishing a data path with a corresponding non-active terminal according to information recorded in the searched list; and
(e) transmitting the buffered data packet to the terminal through the data path.

10. The routing method of claim 9, wherein the non-active terminal list includes non-active mode terminal identification values and a base station connection information.

11. The routing method of claim 9, further comprising:
starting a timer for measuring a data path establishing time after the step (b); and
terminating the timer after the step (d).

12. The routing method of claim 9, wherein the routing table includes a row indicating a second control plane for performing the step (b) to the step (e) through a default path.

13. The routing method of claim 9, wherein the identification value is a MAC identification value.

14. The routing method of claim 9, further comprising the step of sending the received data packet having an identical destination address to the terminal through the data path without a buffering, after the step (e).

15. The routing method of claim 9, wherein the step (d) includes:
delivering a paging message to the terminal;
performing a ranging procedure with the terminal;
performing a network registration procedure of the terminal; and
setting an additional information of a service application for the terminal.

16. A routing method for providing a wireless internet service in case that a terminal is converted into a non-active mode, the method comprising:
receiving a data packet of which a destination is a non-active mode terminal from a core network in a data plane, and performing a routing by using a routing table; and
buffering a data packet which is routed from the data plane in a control plane, and performing a paging to a corresponding non-active mode terminal.

17. The routing method of claim 16, wherein the non-active mode is a sleep mode or an idle mode.

18. The routing method of claim 16, wherein the routing table sets a next-hop for the data packet of which a destination is a non-active terminal to the control plane.

19. The routing method of claim 16, wherein, in the step of performing the paging, a terminal identification value of the data packet is utilized.
